(19) United States
(12) Patent Application Publication
(10) Pub. No.: US 2020/0096962 A1
(43) Pub. Date: Mar. 26, 2020

(54) Field Device and Method for Parameterizing the Field Device

(71) Applicant: Siemens Aktiengesellschaft, Muenchen (DE)

(72) Inventors: Martin Augustin, Karlsruhe (DE); Martin Borrmann, Hagenbach (DE); Michael Klotzbach, Neureut (DE); Marco Milanovic, Karlsruhe (DE); Robin Pramanik, Karlsruhe (DE)

(21) Appl. No.: 16/500,841

(22) PCT Filed: Apr. 4, 2018
(86) PCT No.: PCT/EP2018/058543

§ 371 Date: Oct. 4, 2019

(30) Foreign Application Priority Data
Apr. 5, 2017 (DE) 10 2017 205 832.3

(51) Int. Cl. G05B 19/05; G06F 11/07

(52) U.S. Cl. CPC G05B 19/058; G05B 2219/23213; G05B 2219/25428; G06F 11/0796

(57) ABSTRACT

A field device and method for parameterizing a field device via a parameter, wherein to provide validation, a first checking characteristic is calculated by the field device based on the parameter and a device ID stored, where the first checking characteristic is transferred to an engineering system, the parameter to be validated and the device ID are additionally transferred to the engineering system and are output on a display, where to confirm correct parameterization, a user can input the read first checking characteristic at an operating unit of the engineering system, which first checking characteristic is then transferred back to the field device, where the received checking characteristic is compared with the calculated checking characteristic to validate the parameter such that external calculations of checking characteristics are advantageously unrequired and relation of the validation to the correct field device is ensured.

### CROSS-REFERENCE TO RELATED APPLICATIONS

This is a U.S. national stage of application No. PCT/EP2018/058543 filed Apr. 4, 2018. Priority is claimed on German Application No. 102017205832.3 filed Apr. 5, 2017, the content of which is incorporated herein by reference in its entirety.

### BACKGROUND OF THE INVENTION

### 1. Field of the Invention

The invention relates to a method for parameterizing a field device, in particular a safety-critical field device, which can, for example, be used as a field device for process instrumentation in an automated industrial plant or a power plant and to a field device that can be parameterized correspondingly.

### 2. Description of the Related Art

Automated industrial plants use a wide variety of field devices for process instrumentation to control processes. These are frequently provided with an operating unit upon which, for example, the field device is parameterized by user input for its operation within an automation system of the plant or for displaying process data relating to the field device. Transducers, frequently referred to as sensors, are used to acquire process variables, such as temperature, pressure, flow rate, filling level, density or gas concentration of a medium. Controlling elements, also referred to as actuators, can influence the process sequence as a function of acquired process variables in accordance with a strategy specified by a higher-ranking controller, such as a programmable logic controller or a control station. Examples of actuators include a control valve, heating or a pump.

Networks for data communication via which the field devices are frequently connected to the higher-ranking controller, frequently use fieldbuses operating, for example, in accordance with the protocols PROFIBUS, Highway Addressable Remote Transducer (HART) or Foundation Fieldbus (FF). The configuration, commissioning and monitoring of the automation application implemented with the automation system is performed via a control system. Examples include supervisory control and data acquisition (SCADA) system, Windows Control Center (WinCC) and Process Control System (PCS) such as Simatic PCS 7. In particular, the project planning, parameterization, commissioning, diagnosis and maintenance of field devices can, for example, be performed with the tool Simatic Process Device Manager (PDM).

Special safety requirements apply to the parameterization of field devices, in particular safety-critical field devices, used for the measurement and monitoring of safety-critical plants, systems or processes. Plants subject to requirements according to International Electrotechnical Commission (IEC) standard 61508, i.e., requirements relating to the functional safety of electronic systems that perform safety functions, entail the problem that field devices for commissioning and parameterization generally only have unsafe interfaces, such as HART, PROFIBUS, FF or PROFINET. Consequently, the only communication paths available for communication between the field device and the parameterization unit, which is referred to as an engineering system in the present application, are unsafe paths on which the transferred data may possibly be corrupted. In such an environment, safe remote parameterization, which also includes the steps validation, i.e., verification of the validity of the parameters, and possibly fault acknowledgement, cannot be implemented according to functional safety requirements of, for example, the requirement level Safety Integrity Level 3 (SIL3) without additional technical measures, because the unsafe communication environment on its own could result in a corruption of the parameters. Problems could also be caused by concurrent accesses to the same field device, which could occur, for example, during the commissioning of a plant if a plurality of users wish to put numerous field devices into operation simultaneously.

DE 10 2010 062 908 B4 discloses that the validation of the parameterization of devices can in principle also be performed on site with the aid of a display provided on a field device. For this, the parameters input are displayed on the field device's display. A parameter list in the user's possession containing the parameter IDs (parameter identification codes) and parameter values that correspond to the parameters can be used to verify the correctness of the individual parameters. If the displayed parameters match those shown in the list, the user can confirm, for example, by signing an inspection record that the user-validated parameter values conform to the prespecified values and that, in addition, the correct safety-critical field device has been verified. However, this procedure has the disadvantage that parameter lists for complex field devices usually include a large number of device parameters so that visually checking the individual parameters is very laborious and has a certain susceptibility to errors. Moreover, on-site operator access to safety-critical field devices is frequently difficult.

To avoid these disadvantages, the above-mentioned patent describes a method with which, for validation of the parameters of a field device, in each case a checking characteristic is calculated via a prespecified calculation function, on the one hand, by the field device based on the deposited parameters and a device ID (device identification code) and, on the other, by a, possibly remote, engineering station based on the available parameter list and the device ID. The checking characteristics obtained are compared with one another. The comparison can be performed via the engineering station or the field device.

However, this has the disadvantage that, even in the case of conformity of the calculation function used in the engineering system and in the field device, discrepant checking characteristics could result even though there is sufficient conformity between the parameterization of the field device and the parameter list provided in the engineering system.

### SUMMARY OF THE INVENTION

In view of the foregoing, it is therefore an object of the invention to provide a method for parameterizing a field device and a field device suitable for performing the method, which avoid the aforementioned disadvantage and which moreover enable functionally safe remote parameterization of the field device even via an unsafe network.

This and other objects and advantages are achieved in accordance with the invention by a method for parameterizing a field device and a field device suitable for performing the method, wherein for a clear presentation of the parameterization in accordance with the invention, a first, second, third and fourth logical interface are used. However, reference should be made to the fact that the first interface and the second interface can be the same physical and logical interface. Similarly, the third and the fourth interface can be the same. However, it is important that the parameter is rewritten from the field device to the engineering system using a logical interface that is data-diverse with respect to the interface used to parameterize the field device. In this context, data diversity means that at least different data formats are used for the transfer. For example, the at least one parameter can be transferred via the first logical interface to the field device in the form originally defined in the transfer protocol, while the parameter is, for example, transferred back to the engineering system in a string representation that differs therefrom. The use of data diversity fulfills a requirement for functional safety during the transfer. The same thing applies to the two transfer directions of the first checking characteristic between the field device and the engineering system.

The calculation of a first checking characteristic, which can, for example, be performed using a method known from DE 10 2010 062 908 B4 cited in the introduction, occurs solely via the field device. This has the advantage that no algorithms need to be implemented in the engineering system, i.e., outside the field device, in order to calculate the checking characteristic, thus avoiding the risk of the implementation of the method on engineering systems from different manufacturers leading to different checking characteristics. Hence, this advantageously provides a method for parameterizing a field device that enables a reliably functioning validation of the parameter independently of the respective manufacturer of the engineering system used. Furthermore, the use of an electronic device description file loaded into the engineering system for the commissioning of the field device has the advantage that this does not have to implement any specific calculations of checking characteristics or any methods intended for this purpose in the engineering system. This results in an advantageously high degree of interoperability of the device description file.

The fact that the method is predominantly implemented in the field device means that observance of the procedure is substantially enforced by the field device. The creation of the device description file can be concentrated upon designing a user guide on the engineering system in which a user is prompted to perform a visual check of the parameterization and the device ID on an operating unit of the engineering system and, following a successful verification, to enter a checking characteristic calculated by the field device and displayed on the operating unit of the engineering system for acknowledgement. In addition, advantageously, no special measures are required in the engineering system.

The device ID is included in the calculation of the checking characteristic. As a result, the method permits parameterization of a field device even when the installation of the field device in the plant is retained because it is ensured, via the device ID, that the parameters of the correct field device are being validated and because this avoids problems that could otherwise potentially occur, for example, as the result of multiple occupancy with field devices on fieldbus branches. The method can advantageously be applied independently of the existing automation structure and, for example, in the event of a hierarchical structure, permits the incorporation of the engineering system in any level. The method also advantageously permits parameterization of a field device during the normal operational sequence of the respective plant because no signals are generated that disrupt the other parts of the plant or could influence their functional reliability. In the case of temporary safety faults, triggered, for example, by EMC-interference, the possibility of parameterizing a field device via a remote engineering system and the possibility of activating the field device's safe mode remotely is of great advantage.

In order to keep track of the set of parameters to be verified visually in the validation by the user on a display of the engineering system, a differentiation can be made between user parameters, here referred to as SCUP (safety-critical user parameters) and installation parameters, referred to as SCIP (safety-critical installation parameters). Preferably, only SCUP are offered for a verification of their validity.

Particularly in the case the commissioning of larger plants, it should be assumed that a certain amount of time is consumed by pauses between the individual steps. For example, tanks and piping have to be assembled with pumps etc. Therefore, there is often a time lag between the installation of a field device and the parameterization, validation and function testing of the field device. In order to ensure that a user always knows the point at which commissioning is to be continued, it is particularly advantageous, for example, that the state of a completed validation of the SCUP is deposited in a memory of the field device to ensure that commissioning can be continued at this point. Hence, the progress of the commissioning, even after on/off cycles, is advantageously deposited in the device.

The field device is advantageously provided with write protection in the form of a user-settable PIN code (personal identification number). This measure is commonly used with safety-critical field devices. In order to ensure that the SCUP deposited in the field device cannot be incorrectly changed, an activated write protection is a precondition for transition to the state of completed validation and for remaining there.

On completion of the validation, in accordance with its parameterization, the field device calculates a second checking characteristic with the SCUP and the SCIP and makes the second checking characteristic available to the user on a display of the engineering system so that the user can record the second checking characteristic and verify it to check for any changes in the interim. If there were any changes to the parameterization during the commissioning or in the subsequent operation of the field device, there is also a change to the second checking characteristic calculated by the field device. Hence, the user can also check the validity of the parameterization after on/off cycles. If the second checking characteristic currently calculated by the field device no longer matches the recorded checking characteristic, the user is required to verify the parameterization or repeat the parameterization process. This advantageously enables the integrity of the parameterization to be ensured and suitable measures can be taken in the event of an impermissible change to the parameterization.

The completion of the validation of the SCUP can advantageously be followed by a function test during commissioning to establish the validity of the installation parameters, referred to as SCIP. If the user confirms that the function test has been passed, the SCIP are validated and the field device changes to safe mode. If a fault is established during the function test, then the user is required to cancel the procedure. The field device then changes to unsafe mode. The performance of the function test is not mandatory and can also be skipped via an appropriate user input. However, this is not recommended, although it may be an acceptable solution for certain applications.

In one particularly advantageous embodiment of the invention, the field device comprises an automatic state machine, which differentiates at least between the states unsafe mode, validation, safe mode and safety fault. Advantageously, the automatic state machine drives and monitors the sequence during commissioning, i.e., the automatic state machine ensures observance of a prespecified procedure. The state transitions established in the automatic state machine only occur in the case of valid operator inputs or data transfers between the engineering system and the field device. Invalid entries or data transfers are rejected or ignored and the field device does not change to safe mode, for example.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention and embodiments and advantages are explained in more detail below with reference to the drawings, which depict an exemplary embodiment of the invention, in which:

FIG. 1 is a schematic block diagram of an automation system in accordance with the invention;

FIG. 2 is a schematic block diagram of a safety-critical field device in accordance with the invention;

FIG. 3 is a schematic block diagram of the memory of the field device of FIG. 2; and

FIG. 4 is a state diagram of an automatic machine in the field device in accordance with the invention; and

FIG. 5 is a flowchart of the method in accordance with the invention.

### DETAILED DESCRIPTION OF THE EXEMPLARY EMBODIMENTS

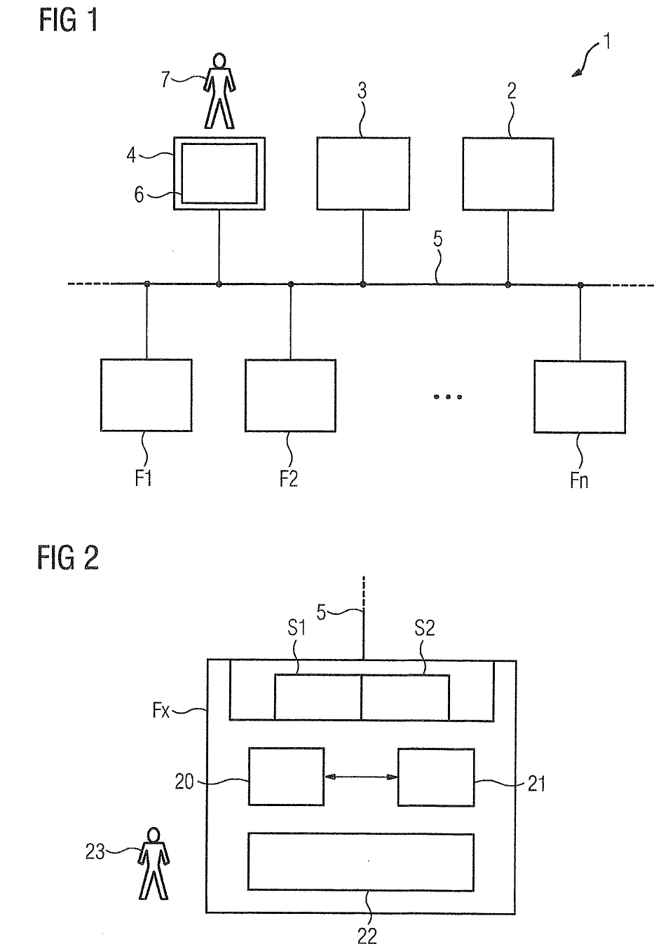

FIG. 1 depicts an automation system 1, which is used in an automated industrial plant, not depicted in further detail, to control a process. In the automation system 1, a control system 2, here a SIMATIC PCS 7, a commissioning tool 3, here a SIMATIC PDM, an engineering station 4 and field devices F1, F2, . . . Fn are interconnected by a network 5 for data communication. The network 5 can be any kind of network, such as an industrial network with a PROFIBUS, PROFINET, HART or FF protocol. However, non-industrial networks, for example a wide area network (WAN), the internet or any wireless networks are also suitable. In contrast to connections for the exchange of process values for functionally safe open-loop/closed-loop control, the network 5 does not have to be subject to functional safety requirements. The commissioning tool 3 and the engineering station 4 are used to parameterize the safety-critical field devices F1, F2, . . . Fn. The engineering station 4 is provided with an operating unit 6 via which a user 7 can make various operator inputs required to perform the method for parameterizing a field device. The operating unit 6 simultaneously serves as a display for outputting data that the operator is required to check visually during the performance of the method.

It should be understood, the control system 2, the commissioning tool 3 and the engineering station 4 can be implemented by any number of computing units, for example, in contrast to the exemplary embodiment depicted, by only one computing unit which then combines the functions of the three components mentioned.

The field devices F1, F2, . . . Fn are each supplied with a safety manual, which describes the exact sequence during the performance of the method. In addition, device description files matching each of the field devices F1, F2, . . . Fn are supplied, where these specify the sequence of the method in the engineering system 4 and operate interfaces so that the data required for the dialogues described in the safety manual is made available.

It should be understood, as an alternative to a device description file written in Electronic Device Description Language (EDDL), the method can be supported on the engineering station side 4 by means/methods such as Device Type Manager (DTM) or Field Device Integration (FDI).

FIG. 2 shows the basic field device structure using the example of a field device Fx, which can be any one of the field devices F1, F2, . . . Fn and which meets the requirements of functional safety. The field device Fx is provided with two logical interfaces S1 and S2, which are both configured for communication via the automation network 5. The interface S2 is data-diverse with respect to the interface S1, which means that, in the exemplary embodiment depicted, separate address spaces and diverse data formats for data transfer are used for the two interfaces S1 and S2. Furthermore, the field device Fx has a computing unit 20, a memory 21 and an operating unit 22, which is provided with a keyboard and a display for on-site operation by a user 23. In the case of purely remote operation, the operating unit 22 can be omitted.

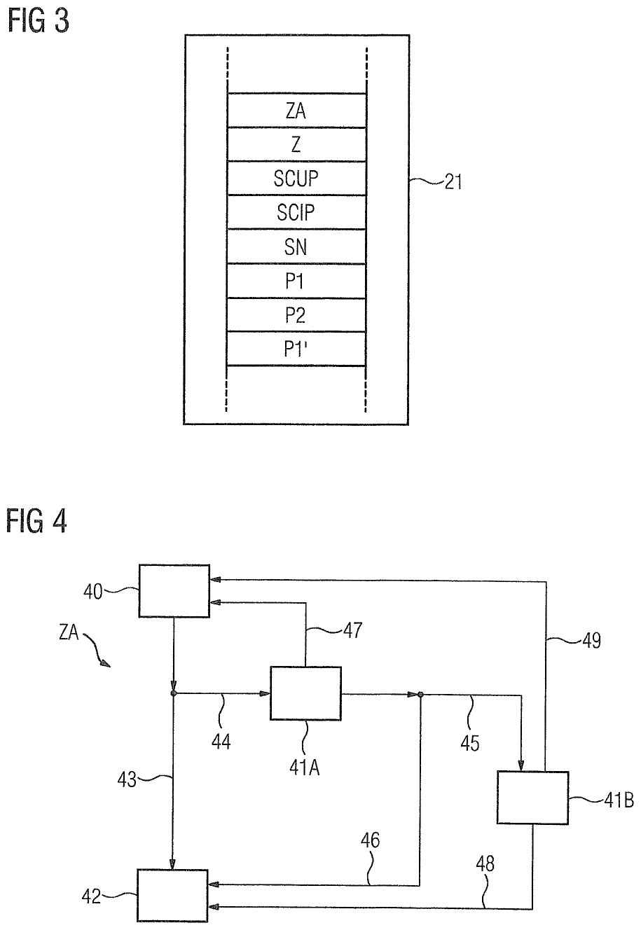

FIG. 3 shows an extract from the content of the memory 21 of the field device Fx (FIG. 2). A program segment for implementing an automatic state machine ZA with encoding of the respective states Z is deposited as part of the firmware. Further memory areas are provided to store the user parameters, SCUP, which can be input into the field device Fx via an operating unit 22 or transferred to the field device Fx via a first logical interface S1, and which are visually checked by the user for validation, and the installation parameters, SCIP, which can be verified via a function test. A serial number SN that is also deposited in the memory 21 is used for the unique identification of the field device Fx (FIG. 2). In addition, values of a first checking characteristic P1, which in the present application, is also referred to as a validation key, and a second checking characteristic P2, hereinafter also referred to as a fingerprint, are deposited in the memory 21. The fingerprint can also incorporate further parameters that are not relevant to safety. Hence, it can also be used for the unique characterization of a configuration. The calculation of the two checking characteristics P1 and P2 is performed within a field device via the computing unit 20 (FIG. 2) based on the user parameters, SCUP, and the serial number SN or based on the user parameters, SCUP, the installation parameters, SCIP, and the serial number SN. For this, a cyclic redundancy check (CRC) function is used in each case. As already described in DE 10 2010 062 908 B4 mentioned in the introduction, it is obviously also alternatively possible to use other known methods to calculate checking characteristics. Another possibility would be a hash function, a simple checksum, a message integrity code (MIC) or a message authentication code (MAC). This list is not complete. An important factor in the selection of the method is a low probability of any other configuration leading to the same result with the calculation of the checking characteristic. In addition, a first checking characteristic P1′ received by the field device during the performance of the method can be deposited in the memory 21.

FIG. 4 is a simplified depiction of an automatic state machine ZA implemented in the field device Fx (FIG. 2). The automatic state machine ZA ensures that a prespecified procedure is observed during the commissioning of the field device. The section of the automatic state machine ZA depicted includes the states unsafe mode 40, validation 41A of the user parameters, SCUP, validation 41B of the installation parameters, SCIP, and safe mode 42. Before a change of state occurs, a check is performed to ensure the request for the change of state is correctly assigned to the respective field device. For this, the automatic state machine ZA checks the serial number SN (FIG. 3) of the field device. If the serial number does not match, then the request is discarded. The use of the automatic state machine ZA, internally calculated checking characteristics P1 and/or P2 and the individual serial number as a device ID excludes the possibility of deviations from the prespecified course, corruption of the parameters or a faulty device assignment. In addition, a plausibility check of the selected parameterization can be performed in the respective field device. Parameters that conflict with the safe mode block transition from the unsafe mode 40 to validation 41A, 41B. The parameters conflicting with the safe mode can be displayed to a user on the display of the operating unit 22 (FIG. 2) or the operating unit 6 (FIG. 1) so the user can effect a remedy by changing the parameters suitably.

Before validation is entered, the field device has been completely parameterized, such as via SIMATIC PDM over the interface S1 (FIG. 2). Each field device has a unique identification feature, a device ID, which is stored in the field device and output on the display of the operating unit 6 (FIG. 1) of the engineering system on each input dialog for checking by the user. The display can, for example, have the following appearance:

Tag: KV1474-F30

Product name: SITRANS P 410

Serial number: 12345678-12345

For this, the serial number can, for example, be read out via the interface S1 (FIG. 2) for the engineering system. In addition, this identification feature can also be applied on the housing of the device. The user is required to record the identification feature and to verify on each input dialog that the correct field device is addressed with the dialog.

Write protection is provided for the device parameters to exclude the possibility of the parameters being changed by unauthorized users or because the device is addressed incorrectly. Transition from the safe mode 40 to validation 41A, 41B is only possible when write protection is activated for the parameters SCUP and SCIP. For the validation process, the write protection is partially deactivated for the user so that only the user inputs required for changing the state of the field device according to FIG. 4 can be performed.

Proceeding from the state 40, the unsafe mode, if the user wishes, it is then possible to follow a direct path 43 to enter the state 42, the safe mode. The user is responsible for the functional safety of his/her plant and is hence responsible for deciding whether or not validation should be performed. This path 43 should only be taken if it can be ensured that parameterization was correct on the delivery of the field device. Therefore, this is not recommended and is only possible with on-site operation on the field device.

On the other hand, a path 44 for entering the state 41A in which first a validation of the user parameters, SCUP, is performed is recommended.

If the fact that the user parameters, SCUP, have already been validated is deposited in the field device memory, then they do not need to be validated again and this step can be skipped. For this, the state of a successful validation of the user parameters, SCUP, is stored in the field device thus enabling, in the event of validation being interrupted, for example, after an on/off cycle, re-entry after the most recently completed step of the validation of the user parameters, SCUP.

If no previous validation of the user parameters, SCUP, has occurred, to enable the validation of the user parameters, SCUP, to be performed by the computing unit 20 (FIG. 2) on the basis of the user parameters, SCUP, and the device ID received via the interface S1 (FIG. 2) and deposited in the memory 21 (FIG. 3), a first checking characteristic P1 (FIG. 3), the so-called validation key is then calculated and stored in the memory 21 (FIG. 3). The validation key P1 is transferred to the engineering station 4 (FIG. 1) as a character string via a second logical interface, which in the example described is identical to the first logical interface S1. In addition, the user parameters, SCUP, are transferred to the engineering system 4 (FIG. 1) via a third logical interface which, in the present application, is identical to the logical interface S2 and data-diverse with respect to the first logical interface S1, in the form of one or more strings. The transfer in string format is only an example of diversity of data transfer. However, also conceivable would be a transfer as an integer instead of a floating-point number or a bit-inverse representation of the transferred data in each case.

Data diversity between the first logical interface S1 and the third logical interface S2 is achieved because an additional address space is used for access via the third logical interface S2 and because, when the parameters are transferred via the first logical interface S1, the data is represented in the form originally defined in the transfer protocol, such as parameterization via SIMATIC PDM, while in the case of back-transfer via the third logical interface S2, a string representation is used. The calculation of the validation Key P1 inter alia includes the device ID. Consequently, the validation key is then unique for each field device even if the parameterization of different field devices is identical. This is, for example, advantageous with a redundant 1oo2 (1 out of 2) architecture in which two field devices of the same type are used.

In addition to the above-described output of the device ID, the user parameters, SCUP, communicated by the field device and the validation key are output on the display of the operating unit 6 of the engineering system 4 (FIG. 1) and in one example depicted as follows with only one user parameter “Measurement Range”:

Measurement Range: 100 mbar

validation key: 56789.

For validation, the user now verifies the correctness of the user parameters, SCUP, and the device ID displayed on the operating unit 6 of the engineering system 4 (FIG. 1), and to confirm their correctness enters the value of the validation key displayed in an input field offered on the display of the operating unit 6. When the validation key has been entered correctly, the user can press a button “Start Function Test” or a button: Skip Function Test to acknowledge the correctness of the displayed values and at the same time select whether there should be a transition from the state 41A via a path 45 into the state 41B, in which the function test is performed or via a path 46 directly into the state 42, namely the safe mode. It should be understood, a button “Cancel” is also provided in addition to the two above-described buttons. If the parameterization has faults, then the user can cancel the validation at this point. The field device then changes from the state 41A via a path 47 into the state 40, the unsafe mode.

When the correctness of the displayed values has been acknowledged, the validation key input is transferred via a fourth logical interface, which is formed as data-diverse with respect to the second logical interface S1, to the field device where it is deposited as a received first checking characteristic P1′ in the memory 21. In the described exemplary embodiment, data diversity is achieved because the back-transfer of the validation key to the field device occurs as a pure numerical value, while a string format is used for the transfer of the validation key calculated in the field device to the engineering station. It should be understood, the required data diversity could alternatively be achieved with reversed data formats for the two transfer directions. The fourth interface used can, for example, be the same interface S2 that is already used to implement the third logical interface.

Transition into the state 41B or 42, only occurs in the event, that it is established in the field device that the received validation key P1′ matches the validation key P1 calculated previously by the field device. In addition, the validation key P1′ is rejected by the field device if the third logical interface S2 was not used for the back-transfer of the user parameters, SCUP, from the field device to the engineering system.

A change of state results in a change to the value of the state code Z (FIG. 3) deposited in the memory 21. As a result, the state of acknowledgement, i.e., the progress achieved in the parameterization of the field device, is also stored in the field device after on/off cycles. The field device calculates a second checking characteristic P2 (FIG. 3), the so-called fingerprint, and deposits this in the memory 21. The calculation of the fingerprint P2 is based on complete parameterization, i.e., the user parameters, SCUP, and the installation parameters, SCIP, and the device ID of the field device. This fingerprint P2 can, on the one hand, be requested by a user 23 on the display of the operating unit 22 of the field device Fx (FIG. 2) 23 and is also, for example, transferred to the engineering system 4 via the logical interface S1 (FIG. 1) so that the value of the fingerprint P2 is output on the remote display of the operating unit 6 (FIG. 1). The display of the fingerprint, for example, in a line Fingerprint: 34512

in turn occurs jointly with the above-described display of the device ID thus enabling unique assignment to the respective field device. The user can record the respective value of the fingerprint P2 for the field device in the user documents thus enabling the validity of the parameterization with reference to the fingerprints P2 even after on/off cycles. This ensures the integrity of the parameterization even after downtimes and despite any concurrent accesses to the parameterization of the field device. If a value of the fingerprint P2 currently calculated by the field device no longer matches the recorded value, a change to the parameterization of the field device is identified and the user can verify the parameterization and if necessary, perform a re-parameterization and validation.

Although it is possible to skip the function test in accordance with the path 46 in FIG. 4, this is not recommended. To ensure functional safety, the user should select the path 45 for the progress of the parameter validation and for performing the function test in the state 41B of the field device. If the function test is passed, then the correctness of the installation parameters, SCIP, should also be checked and transition into the state 42, safe mode, in accordance with a path 48 is possible. To activate the safe mode, the user actuates a button “Function Test Passed and Fingerprint Valid”. If, on the other hand, the user establishes a fault during the function test, a button “Functional Commissioning Test Failed” can be pressed and the field device changes, in accordance with a path 49, to the state 40, i.e. into unsafe mode.

Following the parameterization of a field device, the recommended method, controlled by the automatic state machine ZA (FIG. 3), requires two steps for transition from the unsafe mode, corresponding to state 40 in FIG. 4, into the safe mode, state 42:

First step: Verification of correct parameterization and the validation thereof with the aid of the validation key P1, which includes the device ID, and

Second step: Confirmation that a function test has been passed with a new display of the device ID to ensure input to the correct field device.

For a transition from the safe mode into the unsafe mode, the automatic state machine again requires two steps, although these are not depicted in FIG. 4 for purposes of clarity:

First step: The user requests the desired transition and confirms the device identification and

Second step: The user reconfirms the request for the desired transition.

Only then does the state of the field device change to the unsafe mode. If the input of the confirmation required in the second step does not take place within a prespecified time, then the field device returns to the state safe mode.

For purposes of clarity, FIG. 4 does not depict any further states, such as a safety-fault state. A method for confirming safety faults established in the safe mode, requires a user to check the device ID first. The identified field device only changes to the unsafe mode after confirmation. Therefore, the field device remains in the safety-fault state until the user sends the command to acknowledge, which the device ID contains as a token. It is, therefore, also possible in an advantageous development of the method to leave a fault state and, after revalidation to change back to the safe mode if no permanent error was established without on-site operation of the device being required.

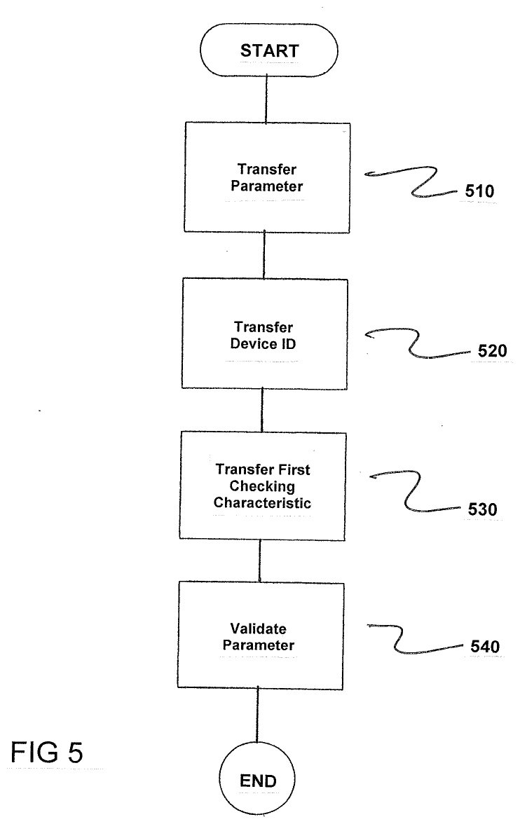

FIG. 5 is a flowchart of the method for parameterizing a field device with at least one parameter, where the at least one parameter SCUP is input into the field device Fx via an operating unit 22 or transferred to the field device Fx via a first logical interface S1 and deposited in a memory 21 of the field device Fx. In accordance with the method of the invention, the field device Fx calculates, based on at least the deposited at least one parameter SCUP and a device ID SN of the field device Fx, a first checking characteristic P1, where the first checking characteristic is also deposited in the memory 21 and transferred via a second logical interface S1 to an engineering system 4 and output on a display 6.

The method comprises, transferring, by the field device Fx, the at least one parameter SCUP via a third logical interface S2 which is data-diverse with respect to the first interface to the engineering system 4 and outputting the at least one parameter SCUP on the display 6, as indicated in step 510. Next, the device ID SN is transferred by the field device Fx to the engineering system 4 and output on the display 6, as indicated in step 520.

Next, a first checking characteristic P1′ input by a user after visual checking the at least one parameter SCUP and the device ID SN on the engineering system 4 in a predefined format is transferred to the field device Fx via a fourth interface S2 which is data-diverse with respect to the second interface, as indicated in step 530.

Next, the received first checking characteristic P1′ comparing by the field device Fx to the calculated first checking characteristic P1 to validate the at least one parameter SCUP, as indicated in step 540.

Thus, while there have been shown, described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-6. (canceled)

7. A method for parameterizing a field device with at least one parameter, the at least one parameter being input into the field device via an operating unit or transferred to the field device via a first logical interface and deposited in a memory of the field device, the field device calculating, based on at least the deposited at least one parameter and a device ID of the field device, a first checking characteristic, the first checking characteristic being also deposited in the memory and transferred via a second logical interface to an engineering system and output on a display, the method comprising:
transferring, by the field device, the at least one parameter via a third logical interface which is data-diverse with respect to the first interface to the engineering system and outputting said at least one parameter on the display;
transferring, by the field device, the device ID to the engineering system and outputting said device ID on the display;
transferring to the field device a first checking characteristic input by a user after visual checking the at least one parameter and the device ID on the engineering system in a predefined format via a fourth interface which is data-diverse with respect to the second interface; and
comparing, by the field device, the received first checking characteristic to the calculated first checking characteristic to validate the at least one parameter.

8. The method as claimed in claim 7, wherein a state of completed validation of the at least one parameter is deposited in the memory of the field device in an event of conformity between the received first checking characteristic and the calculated first checking characteristic.

9. The method as claimed in claim 8, wherein further comprising:
calculating, by the field device calculates upon conclusion of a validation of the at least one parameter, based on parameters deposited in the field device, a second checking characteristic; and
transferring the calculated second checking characteristic to the engineering system and outputting said on the display.

10. The method as claimed in claim 8, wherein a function test is performed on the field device in response to a corresponding input by an user on an operating unit of the engineering system in an event of a completed validation of the at least one parameter; and
wherein the field device changes to a safe mode and this safe mode state is deposited in the memory of the field device in an event of a fault-free completion of the function test, following confirmation thereof, on a corresponding input by a user on the operating unit.

11. The method as claimed in claim 9, wherein a function test is performed on the field device in response to a corresponding input by an user on an operating unit of the engineering system in an event of a completed validation of the at least one parameter; and
wherein the field device changes to a safe mode and this safe mode state is deposited in the memory of the field device in an event of a fault-free completion of the function test, following confirmation thereof, on a corresponding input by a user on the operating unit.

12. The method as claimed in claim 10, wherein validation of the at least one parameter is monitored via an automatic state machine implemented in the field device.

13. A field device for parameterizing the field device with at least one parameter, the field device comprising:
a computing unit; and
memory;
wherein the field device is configured to:
receive at least one parameter via a first logical interface and deposit said received at least one parameter in the memory;
calculate, based on the deposited at least one parameter and a device ID of the field device, a first checking characteristic;
deposit the calculated first checking characteristic in said memory;
transfer said calculated first checking characteristic via a second logical interface to an engineering system for output on a display;
wherein the field device is further configured to:
transfer the at least one parameter via a third logical interface which is data-diverse with respect to the first logical interface to the engineering system for output of at least one parameter on the display;
transfer the device ID to the engineering system;
receive a first checking characteristic on the engineering system input in a predefined format via a fourth interface which is data-diverse to the second interface; and
compare the received first checking characteristic to the calculated first checking characteristic to validation of the at least one parameter.
